(19) United States
(12) Patent Application Publication
(10) Pub. No.: US 2025/0202260 A1
(43) Pub. Date: Jun. 19, 2025

(54) CHARGING METHOD OF LITHIUM BATTERY, LITHIUM BATTERY AND DEVICE

(71) Applicant: ZHUHAI COSMX BATTERY CO., LTD., Zhuhai (CN)

(72) Inventors: Feng WANG, Zhuhai (CN); Suli LI, Zhuhai (CN); Yanming XU, Zhuhai (CN)

(73) Assignee: ZHUHAI COSMX BATTERY CO., LTD., Zhuhai (CN)

(21) Appl. No.: 18/987,422

(22) Filed: Dec. 19, 2024

(30) Foreign Application Priority Data
Dec. 19, 2023 (CN) 202311760235.6

(51) Int. Cl. H02J 7/00; H01M 10/052; H01M 10/42; H01M 10/44

(52) U.S. Cl. CPC H02J 7/00712; H01M 10/052; H01M 10/4257; H01M 10/44; H02J 7/0048

(57) ABSTRACT

A charging method of a lithium battery includes: after reducing a charging upper limit voltage of the lithium battery according to a buck charging strategy, obtaining first index information during a process that the lithium battery adopts the buck charging strategy; when the first index information meets a first preset condition, shutting down the buck charging strategy of the lithium battery and starting a constant-capacity charging strategy. The constant-capacity charging strategy is a charging strategy based on a constant charging capacity of the lithium battery; and after the lithium battery recovers at least part of a capacity loss through the constant-capacity charging strategy, the constant-capacity charging strategy of the lithium battery is shut down. According to the embodiments of the present disclosure, the endurance capability of the lithium battery may be improved, and the service life of the lithium battery may be prolonged.

### CROSS-REFERENCE TO RELATED APPLICATIONS

The present application claims priority to Chinese Patent Application No. 202311760235.6, filed on Dec. 19, 2023, which is hereby incorporated by reference in its entirety.

### TECHNICAL FIELD

The present disclosure relates to the field of battery charging technologies, and in particular, to a charging method of a lithium battery, a lithium battery and a device.

### BACKGROUND

Lithium-ion batteries (lithium batteries for short) are widely used in various electronic products such as mobile terminals, electric tools, electric vehicles, and the like, and consumers have made increasingly higher requirements for service life and endurance capability of the lithium batteries. Especially with the development of technologies such as fast charging, a charging upper limit voltage continues to rise, and at a high voltage, a capacity loss of a lithium battery is also faster. The capacity loss includes a Loss of Lithium Inventory (LLI for short) and a Loss of Active Material (LAM for short). After the endurance capability of the lithium battery is reduced, the charging upper limit voltage of the lithium battery is reduced, which may cause the waste of the active material and the capacity loss, thereby reducing the endurance capability of the lithium battery and shortening the service life. Conventional solutions are to improve the battery life from the perspective of material optimization, system optimization and formula optimization, but those solutions may prolong the product development cycle, improve the product cost, and may even introduce new problems (such as lithium precipitation).

### SUMMARY

Based on the above defects and deficiencies of the related art, the present disclosure provides a charging method of a lithium battery, a lithium battery, an apparatus and a device to solve a problem of a short service life of a lithium battery, which may greatly improve an endurance capability of the lithium battery without changing the lithium battery product itself, and prolong the service life of the lithium battery.

According to a first aspect of embodiments of the present disclosure, a charging method of a lithium battery is provided. The charging method of the lithium battery includes: after reducing a charging upper limit voltage of the lithium battery according to a buck charging strategy, obtaining first index information during a process that the lithium battery adopts the buck charging strategy; when the first index information meets a first preset condition, shutting down the buck charging strategy of the lithium battery and starting a constant-capacity charging strategy of the lithium battery, where the constant-capacity charging strategy is a charging strategy based on a constant charging capacity, and the first preset condition is a first condition set based on a capacity loss caused by reducing the charging upper limit voltage of the lithium battery; and after the lithium battery recovers at least part of the capacity loss through the constant-capacity charging strategy, shutting down the constant-capacity charging strategy of the lithium battery.

According to a second aspect of the embodiments of the present disclosure, a lithium battery is provided, the lithium battery includes a controller, the controller is configured to charge the lithium battery by using the above charging method of the lithium battery.

According to a third aspect of the embodiments of the present disclosure, a charging apparatus of a lithium battery is provided, and the charging apparatus of the lithium battery includes: an index acquisition module configured to: after reducing a charging upper limit voltage of the lithium battery according to a buck charging strategy, obtain first index information during a process that the lithium battery adopts the buck charging strategy; a first strategy control module configured to: when the first index information meets a first preset condition, shut down the buck charging strategy of the lithium battery and start a constant-capacity charging strategy of the lithium battery, where the constant-capacity charging strategy is a charging strategy based on a constant charging capacity, and the first preset condition is a first condition set based on a capacity loss caused by reducing the charging upper limit voltage of the lithium battery; and a second strategy control module configured to: after the lithium battery recovers at least part of the capacity loss through the constant-capacity charging strategy, shut down the constant-capacity charging strategy of the lithium battery.

According to a fourth aspect of the embodiments of the present disclosure, an electronic device is provided, and the electronic device includes a memory and a processor. The memory is connected to the processor and is configured to store programs; and the processor is configured to execute the programs stored in the memory to implement the charging method of the lithium battery according to the first aspect.

In the embodiments of the present disclosure, after reducing the charging upper limit voltage of the lithium battery according to the buck charging strategy, with the reduction of the charging upper limit voltage, the lithium battery produces the waste of active material and the capacity loss. In order to recover the capacity loss caused by the waste of active material, the state of the lithium battery is monitored through the first index information during the process that the lithium battery adopts the buck charging strategy, and when the first index information meets the first preset condition, the buck charging strategy of the lithium battery is shut down and the constant-capacity charging strategy of the lithium battery is started. The first preset condition is a condition set based on the capacity loss caused by reducing the charging upper limit voltage of the lithium battery, ensuring that after the capacity loss occurs, the constant-capacity charging strategy may be started at an appropriate time. The constant-capacity charging strategy is a charging strategy based on a constant charging capacity, the waste active material may be recovered through the constant charging capacity, and an unnecessary capacity loss is recovered, thereby improving the endurance capability of the lithium battery, and prolonging the service life of the lithium battery. Further, during the process that the lithium battery adopts the constant-capacity charging strategy, the timing of shutting down the constant-capacity charging strategy is determined by the second index information, it is ensured by the second preset condition that the constant-capacity charging strategy is shut down immediately when the recovery capacity loss reaches a certain degree, avoiding an excessively high charging upper limit voltage and a permanent battery loss caused by continuously using the constant-capacity charging strategy after the capacity loss caused by the waste of active material is completely recovered. Moreover, the above process only changes the charging strategy of the lithium battery, does not change the lithium battery product itself, and may greatly improve the service life and endurance capability of the lithium battery.

### BRIEF DESCRIPTION OF THE DRAWINGS

In order to more clearly illustrate the embodiments of the present disclosure or technical solutions in the related art, the accompanying drawings required in the description of the embodiments or the related art are briefly described below. Obviously, the accompanying drawings in the following description are merely embodiments of the present disclosure, and for a person of ordinary skill in the art, other drawings may be obtained according to the provided accompanying drawings without creative efforts.

FIG. 1 is a schematic diagram of a buck charging strategy in a full life cycle of a Lithium Cobalt Oxide (LCO) system at 4.5 V in the prior art.

FIG. 2 is schematic diagram of a capacity retention rate before and after buck in the prior art.

FIG. 3 is a schematic flowchart of a charging method of a lithium battery according to an embodiment of the present disclosure.

FIG. 4 is an example diagram of a change curve of a charging voltage or a discharging voltage over time according to an embodiment of the present disclosure.

FIG. 5 is an example diagram of a change curve of a charging voltage or a discharging voltage over time according to another embodiment of the present disclosure.

FIG. 6 is an example diagram of a dV/dQ curve according to an embodiment of the present disclosure.

FIG. 7 is a schematic flowchart of a charging method of a lithium battery according to another embodiment of the present disclosure.

FIG. 8 is an effect comparison diagram of a conventional charging protocol and a capacity recovery scheme according to an embodiment of the present disclosure.

FIG. 9 is an effect comparison diagram of a conventional charging protocol and a capacity recovery scheme according to another embodiment of the present disclosure.

FIG. 10 is an effect comparison diagram of a conventional charging protocol and a capacity recovery scheme according to another embodiment of the present disclosure.

FIG. 11 is an effect comparison diagram of a conventional charging protocol and a capacity recovery scheme according to another embodiment of the present disclosure.

FIG. 12 is a schematic diagram of a Loss of Active Material (LAM) change curves under different working conditions according to an embodiment of the present disclosure.

FIG. 13 is a block diagram of a charging apparatus of a lithium battery according to an embodiment of the present disclosure.

FIG. 14 is a schematic structural diagram of an electronic device according to an embodiment of the present disclosure.

### DETAILED DESCRIPTION OF THE EMBODIMENTS

Technical solutions in the embodiments of the present disclosure are clearly and completely described below with reference to the accompanying drawings in the embodiments of the present disclosure. Obviously, the described embodiments are only a part of the embodiments of the present disclosure, rather than all of the embodiments. All other embodiments obtained by a person of ordinary skill in the art based on the embodiments of the present disclosure without creative efforts shall fall within the protection scope of the present disclosure.

In order to facilitate understanding of the embodiments of the present disclosure, a problem of relatively low service life and endurance capability of the lithium battery is further analyzed.

The service life of the lithium battery may also be understood as a capacity retention rate, an endurance duration, or an endurance mileage of the lithium battery. The service life of the lithium battery is shorter, which means that the capacity retention rate of the lithium battery is lower, the endurance duration is shorter, or the endurance mileage is shorter. The service life of the lithium battery is closely related to the charging strategy of the lithium battery. The capacity loss of the lithium battery at a high voltage is faster, for example, in a Lithium Cobalt Oxide (LCO) system, after the charging voltage is higher than 4.45 volts (V), the capacity loss is faster; and in a Nickel-Cobalt-Manganese (NCM) system, after the charging voltage is higher than 4.3 V, the capacity loss is faster. Specifically, the capacity loss includes a Loss of Lithium Inventory (LLI) and a Loss of Active Material (LAM).

Further, the LAM only occurs at a high voltage, because the high voltage comes from deep delithiation, the material may undergo an irreversible phase transition, and there is no LAM problem at a low voltage. LLI may occur at all voltages, but the higher the voltage, the faster the rate of LLI, so the LLI at low voltage may also be mitigated. In addition, the temperature also accelerates this process. Under the same voltage, the higher the temperature, the more serious the LAM (of course, the more serious the LLI). If high temperature and high voltage are encountered, the LAM may lead to rapid reduction of the battery capacity. Several examples of capacity losses are described below.

(1) The LAM is different at different voltages at the same temperature.

At 45° C., the LAM may be severe when the lithium battery undergoes charging cycles at 4.5 V, but there is almost none of LAM when the lithium battery undergoes charging cycles at 4.4 V.

(2) The LAM is different at different temperatures at the same voltage.

At 45° C., when the lithium battery undergoes charging cycles at 4.5 V, the LAM may be severe, but there is almost none of LAM at 25° C. Almost none does not mean absolute absence, but rather the rate of LAM is merely too low, and it occurs at the later stage, hence the impact may be ignored. For example, when the capacity of the lithium battery is reduced to 80% at 25° C., 20% of the loss includes 19% of LLI and 1% of LAM, but when the capacity of the lithium battery is reduced to 80% at 45° C., the loss may be 8% of LLI and 12% of LAM.

This means that the LAM occurs when the temperature exceeds a certain limit T-spec, the LAM also occurs when the voltage exceeds a certain limit V-spec, and the T-spec and the V-spec affect each other. In actual market use, since the temperature is usually uncontrollable, but the charging upper limit voltage may be easily controlled, so that the LAM may be reduced by reducing the charging upper limit voltage. Based on this mechanism, the buck technology is generated.

The buck charging strategy is to reduce the charging upper limit voltage to a certain extent at intervals during battery's usage. As shown in FIG. 1, taking the LCO system as an example, a buck strategy in the full life cycle at 4.5 V is explained. Under the LCO system, as the service life of the lithium battery is continuously increased (that is, the cycle count that the lithium battery is used is increased continuously), the charging upper limit voltage of the lithium battery is continuously reduced (the capacity retention rate of the lithium battery is decreased accordingly), and the charging upper limit voltage is sequentially reduced to 4.48 V, 4.45 V and 4.4 V from 4.5 V, until the service life of the lithium battery reaches the upper limit.

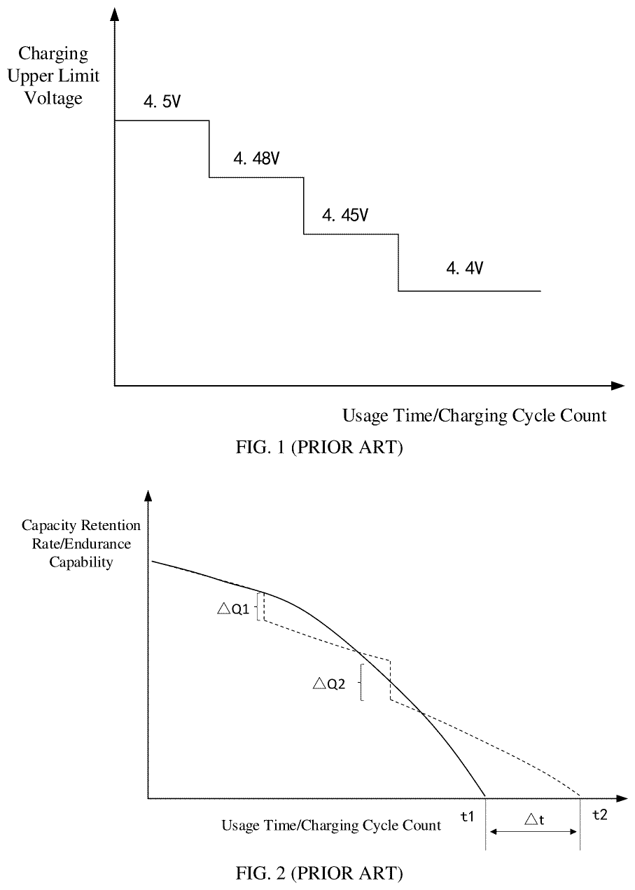

During the buck (or voltage reducing) process, since the charging upper limit voltage is reduced, the electric quantity of the lithium battery cannot be fully charged, and thus the buck strategy may directly lead to a buck loss. As shown in FIG. 2, the capacity retention rate (endurance capability) shows a decreasing trend before and after the buck, the solid line represents the capacity retention rate of the lithium battery before the buck, and the dashed line represents the capacity retention rate of the lithium battery after the buck. FIG. 2 shows two reductions of the charging upper limit voltage, values of loss due to the buck respectively correspond to ΔQ1 and ΔQ2 in FIG. 2, t1 represents the full life of the lithium battery before the buck, t2 represents the full life of the lithium battery after the buck, and ΔQ1 and ΔQ2 are the capacity lost out of thin air. The larger the count of times that the charging upper limit voltage of the lithium battery is reduced, the greater the voltage reduction amplitude, and the greater the buck loss (loss due to voltage reduction). Therefore, if the buck strategy is unreasonable, it may occur that the life of the lithium battery after the buck becomes shorter. For example, LAM does exist at a high temperature (for example, 45° C.), but the rate of LAM is relatively low, if the buck amplitude is too high, a buck loss may be greater than a buck income (income due to voltage reduction), which is a relatively possible situation. For another example, at a room temperature or a low temperature, almost there is no LAM (LAM also exists at the later period of cycles, but the battery may be retired at this time, so that the influence is very small). Although the LLI rate drops slightly after the buck, the buck loss is extremely large, and the buck loss is far greater than the buck income. The purpose of the buck is to prolong the service life of the lithium battery, but an unreasonable buck system results in that the lithium battery cannot be fully charged, and a part of a positive electrode material is not utilized, which indirectly causes waste of the active material.

An existing charging mode includes charging at a constant current up to a charging upper limit voltage, and then transitioning to charging at a constant voltage until a cut-off current is reached; and also there is another fast charging technology of multi-step constant-current constant-voltage charging. Specifically, three existing charging examples are introduced by taking a 4000 mAh lithium battery which is fast charged at a voltage of 4.5 V and a current of 4 C (that is, 16 A) as an example.

(1) Direct charging: charging at a constant current of 4 C (16 A) up to a voltage of 4.5 V, and then transitioning to constant-voltage charging at 4.5 V until a cut-off current 0.05 C (0.2 A) is reached. The current reduces from 16 A to 0.2 A according to a certain curvature, and the battery is fully charged. The risk of direct charging is lithium precipitation, and is large in polarization and long in charging time.

(2) Multi-step constant-current constant-voltage charging: charging at a constant current of 4 C up to a voltage of 4.4 V, transitioning to constant-current charging at 2.7 C up to a voltage of 4.45 V, transitioning to constant-current charging at 1.5 C up to a voltage of 4.5 V, and then transitioning to constant-voltage charging at 4.5 V until a cut-off current of 0.05 C is reached.

(3) Multi-step constant-current constant-voltage overvoltage charging: charging at a constant current of 4 C up to a voltage of 4.4 V, transitioning to constant-current charging at 2.7 C up to a voltage of 4.45 V, transitioning to constant-current charging at 1.5 C up to a voltage of 4.55 V, and then transitioning to constant-voltage charging at 4.55 V until a cut-off current of 0.25 C is reached.

It can be seen that the different charging schemes usually involve constant-current charging in early-stage, and then transitioning to constant-voltage charging after a cut-off voltage is reached. The charging mode of the full life cycle buck strategy is explained by taking the second example, multi-step constant-current constant-voltage charging as an example, which is specifically as follows.

(1) 1-200 cls (cls is a shorthand for cycles, indicating charging cycles, and a single full charge and discharge constitutes one charging cycle): charging at a constant current of 4 C up to a voltage of 4.4 V, and then transitioning to constant-current charging at 2.7 C up to a voltage of 4.45 V, transitioning to constant-current charging at 1.5 C up to a voltage of 4.5 V, and then transitioning to a constant-voltage charging at 4.45 V until a cut-off current of 0.25 C is reached.

(2) 201-300 cls: charging at a constant current of 4 C up to a voltage of 4.4 V, and then transitioning to constant-current charging at 2.7 C up to a voltage of 4.45 V, transitioning to constant-current charging at 1.5 C up to a voltage of 4.48 V, and then transitioning to a constant voltage charging at 4.48 V until a cut-off current of 0.05 C is reached.

(3) 301-500 cls: charging at a constant current of 4 C up to a voltage of 4.4 V, and then transitioning to constant-current charging at 2.7 C up to a voltage of 4.45 V, transitioning to constant-current charging at 1.5 C up to a voltage of 4.46 V, and then transitioning to a constant-voltage charging at 4.46 V until a cut-off current of 0.05 C is reached.

(4) 501-1000 cls: charging at a constant current of 4 C to a voltage of 4.4 V, and then transitioning to constant-current charging at 2.7 C up to a voltage of 4.45 V, and then transitioning to constant-voltage charging at 4.45 V until a cut-off current of 0.05 C is reached.

(5) and so on . . . .

It can be seen that even if the buck is performed, and constant-current constant-voltage charging is performed, only the charging upper limit voltage is changed, and the capacity recovery is not performed. Therefore, each buck results in a large amount of waste of positive electrode material and capacity loss.

Based on the above analysis, it is found that in the existing charging mode, the charging system in the full life cycle involves constant-current and constant-voltage charging, and the buck shall result in a large amount of waste of positive electrode active material and capacity loss. Based on the above, the present disclosure provides a charging method of a lithium battery, by setting constant-capacity charging in a suitable stage, a waste positive electrode material and capacity may be recovered, and thus the cycle life and endurance mileage of the lithium battery are improved, and the service life of the lithium battery is prolonged.

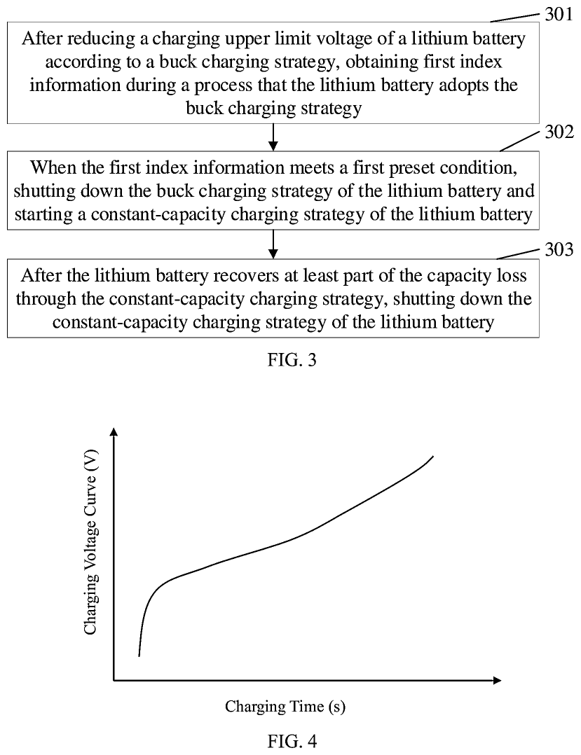

In an embodiment, as shown in FIG. 3, an implementation process of a charging method of a lithium battery is as follows.

Step 301, after reducing a charging upper limit voltage of a lithium battery according to a buck charging strategy, obtaining first index information during a process that the lithium battery adopts the buck charging strategy.

In this embodiment, in an initial stage of usage of the lithium battery, charging is performed according to a preset buck charging strategy, and the buck charging strategy is to avoid the rapid growth of LLI and/or LAM by reducing the charging upper limit voltage. Correspondingly, the reducing of the charging upper limit voltage may cause an unnecessary capacity loss of the lithium battery, and the charging method of the lithium battery is mainly to recover the capacity loss caused by the buck. It should be noted that the buck charging strategy adopted at the initial stage of the lithium battery may be any one of the above mentioned direct charging, multi-step constant-current constant-voltage charging, multi-step constant-current constant-voltage overvoltage charging, and other buck charging methods.

In this embodiment, after reducing the charging upper limit voltage of the lithium battery according to a buck charging strategy, first index information during the process that the lithium battery adopts the buck charging strategy is collected. The first index information refers to real-time information of an index related to the charging and discharging process of the lithium battery during the process that the lithium battery adopts the buck charging strategy. For example, the first index information may be a charging upper limit voltage, a charging cycle count, a real-time charging voltage, a real-time charging current and/or a charging duration during the process that the lithium battery adopts the buck charging strategy.

Step 302, when the first index information meets a first preset condition, shutting down the buck charging strategy of the lithium battery and starting a constant-capacity charging strategy of the lithium battery.

The constant-capacity charging strategy is a charging strategy based on a constant charging capacity, and the first preset condition is a first condition set based on a capacity loss caused by reducing the charging upper limit voltage of the lithium battery.

In this embodiment, the first preset condition is a determination condition preset based on the capacity loss caused by reducing the charging upper limit voltage of the lithium battery. The first preset condition needs to be set in combination with the specific category of the first index information. For example, when a charging cycle count is collected in the first index information, the corresponding first preset condition is set in advance based on the charging cycle count; and when a capacity loss is collected in the first index information, the corresponding first preset condition is set in advance based on the capacity loss. When the first index information meets the first preset condition, it indicates that the capacity loss caused by the reduction of the charging upper limit voltage of the lithium battery has reached a stage suitable for recovery, and at this time, the constant-capacity charging strategy may be started to recover the capacity loss. The constant-capacity charging strategy refers to a charging strategy set based on a constant charging capacity, and in the process of adopting the constant-capacity charging strategy, the charging upper limit voltage is no longer limited by a charging upper limit voltage corresponding to the buck charging strategy adopted at the moment of strategy transitioning, but the constant charging capacity is limited. Each time the lithium battery is charged by adopting the constant-capacity charging strategy, the lithium battery is charged to a constant charging capacity, which indicates that the electric quantity is full, thereby stopping the current charging. It should be noted that the constant charging capacity in the constant-capacity charging strategy may be preset based on the performance of the lithium battery in advance. When the first index information of the lithium battery meets a first preset condition, the constant-capacity charging strategy is started to charge the lithium battery, and the constant-capacity charging strategy may recover an unnecessary capacity loss caused by the reduction of the charging upper limit voltage, thereby prolonging the overall service life of the lithium battery and improving the endurance capability of the lithium battery.

Step 303, after the lithium battery recovers at least part of the capacity loss through the constant-capacity charging strategy, shutting down the constant-capacity charging strategy of the lithium battery.

In this embodiment, after starting the constant-capacity charging strategy of the lithium battery, the unnecessary capacity loss may be recovered through the constant-capacity charging strategy. After the lithium battery is charged by adopting the constant-capacity charging strategy for a period, and a certain amount of capacity loss is recovered by the lithium battery through the constant-capacity charging strategy, the constant-capacity charging strategy of the lithium battery may be shut down, avoiding potential safety hazards such as overlarge charging upper limit voltage or overlarge charging current caused by always adopting the constant charging capacity to charge the lithium battery, so as to ensure the safety in the process of charging the lithium battery.

In an embodiment, the step of after the lithium battery recovers at least part of the capacity loss through the constant-capacity charging strategy, shutting down the constant-capacity charging strategy of the lithium battery, specifically includes: obtaining second index information during a process that the lithium battery adopts the constant-capacity charging strategy; and when the second index information meets a second preset condition, shutting down the constant-capacity charging strategy of the lithium battery, and restarting the buck charging strategy of the lithium battery. The second preset condition is a second condition set based on the at least part of the capacity loss recovered by the lithium battery through the constant-capacity charging strategy.

In this embodiment, the timing of shutting down the constant-capacity charging strategy may be determined according to a second index information in the process that the lithium battery adopts the constant-capacity charging strategy. The second index information refers to real-time information of an index related to the charging and discharging process of the lithium battery during the process that the lithium battery adopts the constant-capacity charging strategy. For example, the second index information may be a charging upper limit voltage, a charging cycle count, a real-time charging voltage, a real-time charging current and/or a charging duration during the process that the lithium battery adopts the constant-capacity charging strategy.

In this embodiment, the second preset condition is a second condition set through the capacity loss recovered through the constant-capacity charging strategy, and the second preset condition needs to be set in combination with the specific category of the second index information. For example, when a charging cycle count is collected in the second index information, the corresponding second preset condition is set in advance based on the charging cycle count; and when a capacity loss is collected in the second index information, the corresponding second preset condition is set in advance based on the capacity loss. The timing of shutting down the constant-capacity charging strategy is determined through the second preset condition, meanwhile, the charging strategy of the lithium battery is transitioned into the buck charging strategy again, and the lithium battery is continuously charged by adopting the buck charging strategy again, so that the lithium battery may still be normally and safely charged after the constant-capacity charging strategy is shut down.

In an embodiment, the first index information may be a real-time charging cycle count for charging the lithium battery, and correspondingly, the first preset condition is a first preset cycle count. Specifically, the step of obtaining first index information during a process that the lithium battery adopts the buck charging strategy includes: obtaining a real-time charging cycle count (a first real-time charging cycle count) of the lithium battery during the process that the lithium battery adopts the buck charging strategy. When the first index information meets the first preset condition, shutting down the buck charging strategy of the lithium battery and starting a constant-capacity charging strategy of the lithium battery, includes: when the real-time charging cycle count reaches a first preset cycle count, shutting down the buck charging strategy of the lithium battery and starting the constant-capacity charging strategy of the lithium battery. The first preset cycle count is a charging cycle count set based on the capacity loss caused by reducing the charging upper limit voltage of the lithium battery.

In this embodiment, the real-time charging cycle count refers to a cumulative count of lithium battery charging cycles, and one charging cycle of the lithium battery is set according to the specific use environment and actual requirements of the lithium battery. For example, a full charge or discharge of the lithium battery constitutes one charging cycle, or the lithium battery is charged until the state of charge (SOC) reaches 90% each time constitutes one charging cycle. The start timing of accumulating the charging cycle may also be set according to specific conditions and actual requirements. For example, if the start timing of the real-time charging cycle count is a moment that the lithium battery is put into use, the real-time charging cycle count is the cumulative count of charging cycles from the moment that the lithium battery is put into use to the current time; or, if the start timing of the real-time charging cycle count is a moment that the lithium battery leave a factory, the real-time charging cycle count is the cumulative count of charging cycles from the moment that the lithium battery leave a factory to the current time.

In this embodiment, the larger the real-time charging cycle count, the more the count of times that the lithium battery is charged, the more capacity loss caused by the lithium battery by adopting the buck charging policy. The degree of capacity loss of the lithium battery may be represented by a preset first preset cycle count. The first preset cycle count is a preset charging cycle count set according to specific conditions and actual requirements. When the real-time charging cycle count reaches the first preset cycle count, it indicates that the capacity loss of the lithium battery has reached the stage suitable for recovering the capacity loss, and the charging strategy is immediately transitioned to the constant-capacity charging strategy. During a process of charging the lithium battery by adopting the constant-capacity charging strategy, the charging upper limit voltage of the lithium battery is not limited, but it is ensured that the charging capacity of each charging cycle of the lithium battery is a constant charging capacity, thereby recovering the lost positive electrode material and capacity.

In an embodiment, the step of obtaining second index information during a process that the lithium battery adopts the constant-capacity charging strategy, specifically includes: obtaining a real-time charging cycle count again (a second real-time charging cycle count) of the lithium battery during the process that the lithium battery adopts the constant-capacity charging strategy. When the second index information meets the second preset condition, shutting down the constant-capacity charging strategy of the lithium battery and restarting the buck charging strategy of the lithium battery, specifically includes: when the real-time charging cycle count obtained again reaches a second preset cycle count, shutting down the constant-capacity charging strategy of the lithium battery and restarting the buck charging strategy of the lithium battery. The second preset cycle count is a charging cycle count set based on the at least part of the capacity loss recovered through the constant-capacity charging strategy of the lithium battery.

In this embodiment, the second index information is the real-time charging cycle count during the process that the lithium battery adopts the constant-capacity charging strategy, the second preset condition is the second preset cycle count, and the second preset cycle count is greater than the first preset cycle count. The second preset cycle count is also a preset charging cycle count set according to specific conditions and actual requirements. When the real-time charging cycle count reaches the second preset cycle count, it indicates that the capacity loss of the lithium battery has been recovered to a reasonable level. At this time, the recovery process can be stopped, the constant-capacity charging strategy is stopped, and the charging strategy is transitioned to the original buck charging strategy, so that the service life of the lithium battery is prolonged, and the endurance capability of the lithium battery is improved.

In a specific embodiment, when the first preset cycle count and the second preset cycle count in the foregoing embodiments are preset, they may be preset in advance according to the data in the battery development process to implement the transition of the charging and discharging strategy. For example, dV/dQ is drawn using a discharging curve, and LLI and LAM are read based on the data. Specifically, it is assumed that a charging and discharging device (the device includes a lithium battery of the same type) collects a point at an interval of 10 s, there are a series of voltage values V1, V2, V3, V4 and the like, as well as a series of capacity values Q1, Q2, Q3, Q4 and the like which are obtained by a full charge (or full discharge) of the lithium battery in the plurality of charging cycles. The dV/dQ may be converted into discrete ΔV/ΔQ for differential calculation, where ΔV represents a voltage difference caused by buck, and ΔQ represents a capacity loss caused by buck, as follows:

$$( V 1 - V 2 ) / ( Q 1 - Q 2 ) , \\ ( V 2 - V 3 ) / ( Q 2 - Q 3 ) , \\ ( V 3 - V 4 ) / ( Q 3 - Q 4 ) ,$$

Taking a series of points obtained after the differential calculation as the ordinate and Q as the abscissa, the relationship between dV/dQ and Q is obtained, and then LLI and LAM are calculated. The first preset cycle count and the second preset cycle count are set.

In this embodiment, the first preset cycle count and the second cycle count used for starting the constant-capacity charging mode are preset according to empirical data and/or experimental data of the lithium battery of the same type, and although the first preset cycle count and the second preset cycle count cannot very accurately represent the real-time service life of an individual lithium battery, the existing deviation is smaller. Moreover, the setting modes of the first preset cycle count and the second preset cycle count are more practical and easier to be implemented in an actual production environment.

In this embodiment, according to the data in the battery development process, for example, by using an existing technology, a change curve of the real-time capacity and the real-time voltage is drawn by using a discharging curve of the lithium battery, that is, the dV/dQ curve. The LLI and the LAM are read based on the data, and it is easier for engineering implement to implement the transition between the buck charging strategy and the constant-capacity charging strategy after a plurality of cycles set in advance. In an example, during the process that the lithium battery adopts the buck charging strategy to charge the lithium battery, it is set that the voltage is reduced by 20 mV each time when the real-time charging cycle count reaches 200, 300 and 500 times, respectively, and thus the charging upper limit voltage of the lithium battery may be automatically reduced after the respective charging cycle count is reached. Similarly, according to experimental data, after the real-time charging cycle count reaches 380, 540 or 620 times, the capacity of the lithium battery is reduced to 85%. At this time, the charging strategy is transitioned into a constant-capacity charging strategy, and the charging strategy is transitioned from the constant-capacity charging strategy to the constant-voltage charging strategy after the real-time charging cycle count reaches the preset second preset cycle count, for example, the real-time constant-capacity charging cycle count reaches 50 times and then the constant-capacity charging strategy is changed into the constant-voltage charging strategy.

In an embodiment, the first index information is a real-time capacity loss caused by reducing the charging upper limit voltage of the lithium battery, and the first preset condition is a preset loss threshold. Specifically, the step of obtaining first index information during a process that the lithium battery adopts the buck charging strategy includes: during the process that the lithium battery adopts the buck charging strategy, obtaining a corresponding relationship between a charging voltage and time or a discharging voltage and time of the lithium battery; based on the corresponding relationship between the charging voltage and time or the discharging voltage and time, obtaining a corresponding relationship between a remaining power and an open circuit voltage of the lithium battery; and based on the corresponding relationship between the remaining power and the open circuit voltage, calculating a real-time capacity loss caused by reducing the charging upper limit voltage of the lithium battery. When the first index information meets the first preset condition, shutting down the buck charging strategy of the lithium battery and starting the constant-capacity charging strategy of the lithium battery includes: in a case that the real-time capacity loss reaches a preset loss threshold, shutting down the buck charging strategy of the lithium battery and starting the constant-capacity charging strategy of the lithium battery.

In this embodiment, the real-time capacity loss during the process that the lithium battery adopts the buck charging strategy can be obtained in real time, and the adaptive transition of the charging strategy can be achieved through the real-time capacity loss. Further, the real-time capacity loss may be calculated by the corresponding relationship between the remaining power and the open circuit voltage. The corresponding relationship between the remaining power and the open circuit voltage may be represented by a corresponding curve of the State of Charge (SOC) and the Open Circuit Voltage (OCV), and the Battery Management System (BMS) of the lithium battery may also map the SOC-OCV curve in real time by using the corresponding relationship between the charging voltage and time (which may be mapped as a charging curve) or the corresponding relationship between the discharge voltage and time (which may be mapped as a discharging curve). The SOC-OCV curve of the battery is recorded in the BMS (or the whole machine), and the corresponding buck capacity loss ΔQ after the buck ΔV may be known according to the curve. It is assumed that the voltage of the lithium battery has reduced n times (n≥1) before the capacity retention rate is reduced to 85%, the total real-time capacity loss caused by total voltage reduction is:

$$Δ Q = {\sum }_{i = 1}^{n} {Q}_{i} ( n \geq 1 ) ,$$

where Qᵢ is the capacity loss caused by the i-th voltage reduction, this part of capacity loss is caused by not fully charging after the voltage reduction (for example, the charging upper limit voltage decreases from 4.5 V to 4.48 V, then to 4.46 V . . . , resulting in that the battery is not fully charged compared with a fresh battery, where the fresh battery may be an unused battery that can be purchased on the market or a battery of which the cycle count that can be read by means of a BMS or the like does not exceed 10 cycles.

When ΔQ>0, representing that a buck charging strategy has led to a real-time capacity loss, the charging strategy can be transitioned from a conventional buck charging strategy to a constant-capacity charging strategy. Under the constant-capacity charging strategy, since the capacity retention rate is unchanged (that is, a charging process is based on a constant charging capacity) during full charging, the charging upper limit voltage is slowly increased. At this time, the LLI and LAM are mainly supplemented by the unexploited capacity loss caused by voltage reduction, then the capacity loss and material waste caused by voltage reduction are recovered, and material recycling is achieved.

In an embodiment, in the case that the real-time capacity loss reaches the preset loss threshold, shutting down the buck charging strategy of the lithium battery and starting the constant-capacity charging strategy of the lithium battery includes: in the case that the real-time capacity loss reaches the preset loss threshold, obtaining a real-time capacity retention rate of the lithium battery; and when the real-time capacity retention rate is less than or equal to a preset retention rate threshold, shutting down the buck charging strategy of the lithium battery and starting the constant-capacity charging strategy of the lithium battery.

In this embodiment, after the real-time capacity loss occurs, the real-time capacity loss can be immediately recovered, but it is assumed that the real-time capacity loss is small, the capacity loss recovered through the constant-capacity charging strategy is also limited, and therefore, the efficiency of strategy transition is low. Preferably, the real-time capacity loss ΔQ>0 is used as a prerequisite, and the reduction condition of the real-time capacity retention rate is taken as a preferred condition. The real-time capacity retention rate of the lithium battery is obtained under the condition that the real-time capacity loss reaches a preset loss threshold. When the real-time capacity retention rate is less than or equal to a preset retention rate threshold, indicating that the real-time capacity loss has accumulated more, at the moment, the buck charging strategy of the lithium battery is shut down, and the constant-capacity charging strategy of the lithium battery is started. Therefore, energy recovery can be achieved more efficiently, and the recovery efficiency is relatively high. The preset retention rate threshold may be set according to specific conditions and occasions, for example, the preset retention rate threshold is preferably set to 85% or 80%, and for example, any value of 60% to 90% may also be selected as the preset retention rate threshold according to timing requirements.

In an embodiment, the second index information is a loss of active material of the lithium battery, and the second preset condition is a relationship between the loss of active material and the total capacity loss caused by reducing the charging upper limit voltage by the lithium battery. Specifically, the step of obtaining second index information during a process that the lithium battery adopts the constant-capacity charging strategy includes: during the process that the lithium battery adopts the constant-capacity charging strategy, obtaining a corresponding relationship between a charging voltage and time or a discharging voltage and time of the lithium battery; based on the corresponding relationship between the charging voltage and time or the discharging voltage and time, obtaining a corresponding relationship between a real-time capacity and a real-time voltage of the lithium battery; based on the corresponding relationship between the real-time capacity and the real-time voltage, calculating a loss of active material of the lithium battery. when the second index information meets the second preset condition, shutting down the constant-capacity charging strategy of the lithium battery and restarting the buck charging strategy of the lithium battery includes: when the loss of active material is greater than or equal to a total capacity loss caused by reducing the charging upper limit voltage of the lithium battery, shutting down the constant-capacity charging strategy of the lithium battery and restarting the buck charging strategy of the lithium battery.

In this embodiment, at the moment of transitioning the charging strategy, the total capacity loss caused by reducing the charging upper limit voltage during the process that the lithium battery adopts the buck charging strategy can be calculated. Transitioning the charging strategy to the constant-capacity charging strategy to recover energy is essentially to cover the loss of active material of the lithium battery through the recovered capacity. Therefore, the timing of shutting down the constant-capacity charging strategy may be determined by calculating the loss of active material of the lithium battery, and comparing the loss of active material calculated in real time and the total capacity loss caused by reducing the charging upper limit voltage of the lithium battery.

Specifically, according to the corresponding relationship between the charging voltage and time of the lithium battery or the corresponding relationship between the discharging voltage and the time, the charging curve or the discharging curve of the lithium battery is mapped in real time, a change curve between the real-time capacity and the real-time voltage, that is, the dV/dQ curve, is depicted based on the charging curve or the discharging curve, and then the loss of active material of the lithium battery is calculated according to the dV/dQ curve. During the process that the lithium battery adopts the constant-capacity charging strategy, if LAM≥ΔQ, the constant-capacity charging strategy is shut down, and the constant-capacity charging strategy is transitioned to a conventional buck charging strategy.

In this embodiment, obtaining a complete charging curve or a complete discharging curve is the first step for calculating the loss of active material, but there are two cases for mapping the charging curve or the discharging curve.

In the first case, when the complete charging curve (or the discharging curve) can be directly measured, a complete charging curve (or a discharging curve) obtained during the process that the lithium battery adopts the constant-capacity charging strategy is used to depict dV/dQ (or dQ/dV), and the LLI and the LAM are calculated. The current LLI and LAM are recorded before and after the transition of the charging strategy, respectively, and when LAM≥ΔQ during the process that the lithium battery adopts the constant-capacity charging strategy, the constant-capacity charging strategy is shut down, and the constant-capacity charging strategy is transitioned to a conventional buck charging strategy.

In the second case, when a complete charging curve (or a discharging curve) cannot be obtained through measurement, a complete SOC-OCV curve is estimated by using an existing algorithm, and LLI and LAM can be calculated. The current LLI and LAM are recorded before and after the transition of the charging strategy, respectively, and when LAM≥ΔQ during the process that the lithium battery adopts the constant-capacity charging strategy, the constant-capacity charging strategy is shut down, and the constant-capacity charging strategy is transitioned to a conventional buck charging strategy.

For example, as shown in FIG. 4, in some working conditions, a complete change curve of a charging voltage or a discharge voltage over time may be obtained, and a battery capacity is an integral of current over time, that is,

$$Q = \int Idt ( or discrete Q = I \cdot Δ t )$$

Therefore, after obtaining a voltage-time curve, a voltage-capacity curve can be easily calculated.

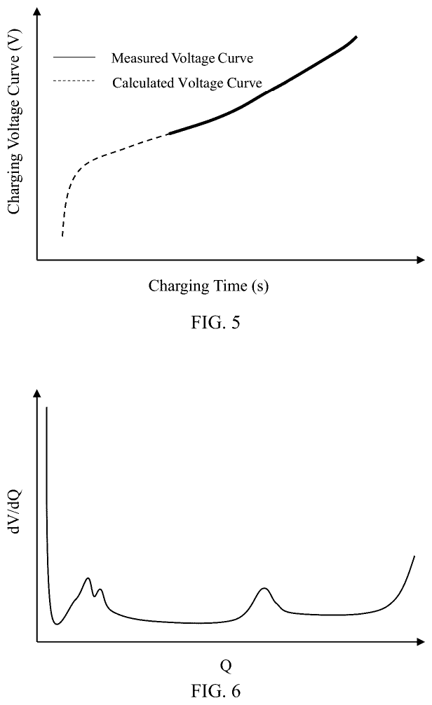

As shown in FIG. 5, a complete voltage-time curve cannot be obtained under certain working conditions, and only a part of the curve can be detected, as shown in the solid line part in FIG. 5. A complete charging curve (or discharging curve) can be estimated by using an existing method (for example, a neural network model, an equivalent circuit model, an Extended Kalman Filter (EKF) algorithm, and the like), as shown in FIG. 5.

Regardless of the above method, the corresponding SOC-OCV curve can be calculated as long as the complete charging curve (or discharging curve) is obtained, and then the dV/dQ (e.g., dV/dQ curve as shown in FIG. 6) is calculated according to the well-known method, so as to calculate LLI and LAM.

In an embodiment, a process that the lithium battery adopts the constant-capacity charging strategy specifically includes: obtaining a real-time charging current of the lithium battery and a real-time charging capacity of the lithium battery; and when the real-time charging current reaches a preset current threshold, maintaining the real-time charging current unchanged, and continuously charging the lithium battery until the real-time charging capacity reaches the constant charging capacity.

In this embodiment, after the lithium battery enters the stage of constant-capacity charging, the real-time charging capacity of each charging cycle reaches a constant charging capacity based on a constant charging current. For each charging cycle, when the real-time charging current reaches the preset current threshold, the charging upper limit voltage is not limited in the process of maintaining the real-time charging current unchanged, and in a plurality of consecutive charging cycles, the charging upper limit voltage gradually increases, thereby recovering the capacity loss. Normally, since the capacity loss occurs before the constant-capacity charging stage of the lithium battery, and there is a limitation of the second preset condition, the charging upper limit voltage in the constant-capacity charging stage does not exceed a system upper limit voltage of the lithium battery. Based on experience, increase of the charging upper limit voltage of the lithium battery is roughly on the order of tens of millivolts. The system upper limit voltage refers to the upper limit voltage of the whole life cycle of the lithium battery.

Further, in order to avoid an unexpected situation of the charging system of the lithium battery in the constant-capacity charging process, the real-time charging voltage of the lithium battery is obtained in the process of charging the lithium battery by maintaining the real-time charging current unchanged for each charging cycle in a constant-capacity charging stage. If the real-time charging voltage reaches the system upper limit voltage, the real-time charging voltage is maintained unchanged, and the real-time charging current is gradually reduced until the real-time charging capacity reaches a constant charging capacity, and in this charging cycle, the charging process for the lithium battery is stopped. The above process may improve the safety in the charging process of the lithium battery, and avoid excessively high charging voltage of the lithium battery caused by unexpected situations; and meanwhile, based on the characteristic of the constant-capacity charging, the constant-capacity charging of each charging cycle may be completed under a safety condition.

In an embodiment, the preset current threshold is a current value corresponding to a charging upper limit voltage of the lithium battery under a constant charging capacity.

In this embodiment, in order to ensure that the constant-capacity charging is implemented safely, and the electric quantity can be quickly charged, the preset current threshold is preferably set to a current value corresponding to the charging upper limit voltage of the lithium battery under a constant charging capacity. Certainly, when there are other requirements, on the premise of ensuring normal implementation of the present disclosure, the preset current threshold may also be set according to other principles and needs.

In an embodiment, after the step of restarting the buck charging strategy of the lithium battery, the charging method of the lithium battery further includes: obtaining third index information in a process that the lithium battery adopts the buck charging strategy; and when the third index information reaches a third preset condition, shutting down the buck charging strategy of the lithium battery again, and restarting the constant-capacity charging strategy of the lithium battery. The third preset condition is a third condition set based on the capacity loss caused by reducing the charging upper limit voltage of the lithium battery.

In this embodiment, after the buck charging strategy of the lithium battery is restarted, the constant-capacity charging strategy can be started again, that is, the constant-capacity charging strategy can be started multiple times in the whole life cycle of the lithium battery, as long as the corresponding preset condition is set in advance. Therefore, multiple capacity loss recovery of the whole life cycle of the lithium battery is achieved, and the service life of the lithium battery is further prolonged.

In an embodiment, when the second index information meets the second preset condition, shutting down the constant-capacity charging strategy of the lithium battery and restarting the buck charging strategy of the lithium battery includes: when the second index information meets the second preset condition, charging the lithium battery according to a real-time charging voltage of the lithium battery being less than or equal to a charging upper limit voltage corresponding to the constant charging capacity.

In this embodiment, after the constant-capacity charging stage is shut down, in order to ensure the effectiveness of capacity recovery and prevent the recovery capacity from being quickly lost again, preferably, the real-time charging voltage of the lithium battery is limited being less than or equal to the charging upper limit voltage corresponding to the constant charging capacity, that is, the charging upper limit voltage of each charging cycle after the constant-capacity charging stage is shut down is less than or equal to the charging upper limit voltage corresponding to the constant charging capacity. Certainly, when there are other requirements, on the premise of ensuring normal implementation of the present disclosure, the charging upper limit voltage of each charging cycle after the constant-capacity charging stage is shut down may also be set according to other principles and needs.

In an embodiment, the constant charging capacity is preset based on the capacity loss rate (the capacity retention rate) of the lithium battery; and a value range of the capacity retention rate is preferably 80%˜85%, including two end values of 80% and 85%.

In this embodiment, based on experimental data and empirical data, it can be seen that, when the capacity retention rate is reduced to 80%˜85%, it is better to change to the constant-capacity charging. The reason is that the buck amplitude is relatively large at this time, and the recovery of an unused positive electrode material is more valuable. Certainly, the value range of the capacity retention rate may also be expanded to 60%˜90% according to needs, including two end values of 60% and 90%.

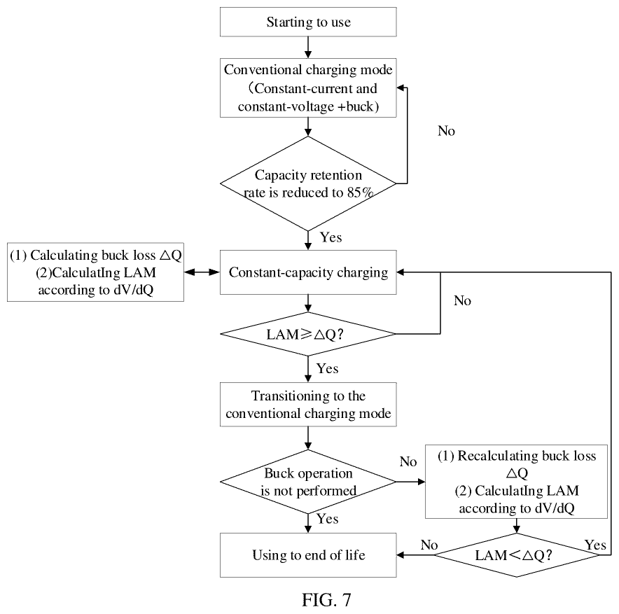

In a whole embodiment, based on the foregoing embodiments, as shown in FIG. 7, a specific process of implementing the charging method of the lithium battery provided in the present disclosure is as follows.

After the lithium battery is used, a conventional charging scheme is adopted to charge the lithium battery first, and preferably, a constant-current constant-voltage and buck scheme is adopted. In the implementation process of the conventional charging scheme, whether the capacity retention rate of the lithium battery is reduced to 85% is monitored, and if not, the monitoring process continues; and if yes, the charging mode is transitioned to the constant-capacity charging mode. The process of monitoring the capacity retention rate to implement the transition of the charging mode may be implemented based on the charging cycle count. Specifically, the capacity value loss ΔQ caused by a buck operation is calculated. After the buck operation is performed on the lithium battery, the capacity value loss ΔQ may exist in the subsequent charging cycle because the lithium battery cannot be charged to the initial maximum capacity value. For example, the charging upper limit voltage of a certain lithium battery is reduced from 4.55 V to 4.53 V, and the capacity loss corresponds to the voltage reduction of 20 mV is the capacity value loss ΔQ. dV/dQ is obtained based on ΔQ, then the LAM is calculated according to the dV/dQ, and whether to transition the charging mode is determined according to whether the real-time charging cycle count reaches the first preset cycle count.

In the constant-capacity charging process, it is determined in real time whether the recovered LAM reaches the capacity value loss ΔQ (implemented by the second preset cycle count) caused by the previous buck process, if not, a constant-capacity charging mode is continued; and if yes, the constant-capacity charging mode is transitioned to a conventional charging mode.

In the process of adopting the conventional charging mode, it is determined whether the previous constant-current constant-voltage and buck scheme is continuously adopted in this conventional charging stage, if the buck operation is not needed, the lithium battery continues to be used until the end of its service life, and if the constant-current constant-voltage and buck scheme is still adopted, the capacity value loss ΔQ caused by the buck operation is recalculated in the buck process, and the LAM is recalculated according to the dV/dQ. Then, it is determined whether the re-calculated LAM is smaller than the re-calculated capacity value loss ΔQ, if yes, the charging mode is transitioned to the constant-capacity charging mode again, and if not, the lithium battery is directly used until the end of its service life.

In this embodiment, in an actual use scenario, usually, 80% of State of Health (SOH) is regard as a cutoff service life of a consumer lithium battery, but the consumer may continue to use the consumer lithium battery after the SOH is less than or equal to 80%, and the power and energy storage may even be lowered to 70%, 60% or 50% as a cutoff service life. In these cases, as long as the buck operation is continued, the buck loss may be recovered by more constant-capacity charging.

In another specific embodiment, based on the foregoing embodiments, a specific example of improving a material utilization rate and a service life of the lithium battery is provided. In this embodiment, a fast charging system in which the voltage is 4.5 V, a current is 4 C, a capacity is 4000 mAh and cycles are performed at 35° C. is taken as an example.

A process of charging the lithium battery by adopting an existing charging algorithm optimization technology (for example, a Flash Fast Charge, FFC) includes the following contents.

(1) 1-200 cls: charging at 4 C (16 A) up to 4.38 V, transitioning to charging at 3.2 C up to 4.43 V, transitioning to charging at 2.5 C up to 4.45 V, transitioning to charging at 2 C up to 4.48 V, transitioning to charging at 1.2 C up to 4.55 V, and then performing constant voltage charging at 4.55 V until a cut-off current is less than 0.32 C;

(2) 201-500 cls: charging at 4 C (16 A) up to 4.38 V, transitioning to charging at 3.2 C up to 4.43 V, transitioning to charging at 2.5 C up to 4.45 V, transitioning to charging at 2 C up to 4.48 V, transitioning to charging at 1.2 C up to 4.53 V, and then performing constant voltage charging at 4.53 V until a cut-off current is less than 0.32 C;

(3) 501-800 cls: charging at 4 C (16 A) up to 4.38 V, transitioning to charging at 3.2 C up to 4.43 V, transitioning to charging at 2.5 C up to 4.45 V, transitioning to charging at 2 C up to 4.48 V, transitioning to charging at 1.2 C up to 4.51 V, and then performing constant voltage charging at 4.51 V until a cut-off current is less than 0.32 C;

(4) 801-2000 cls: charging at 4 C (16 A) up to 4.38 V, transitioning to charging at 3.2 C up to 4.43 V, transitioning to charging at 2.5 C up to 4.45 V, transitioning to charging at 2 C up to 4.48 V, and then performing constant voltage charging at 4.48 V until a cut-off current is less than 0.32 C.

A charging process of a lithium battery by adopting the charging method of the lithium battery provided in the present disclosure includes the following contents.

(1) 1-200 cls: charging at 4 C (16 A) up to 4.38 V, transitioning to charging at 3.2 C up to 4.43 V, transitioning to charging at 2.5 C up to 4.45 V, transitioning to charging at 2 C up to 4.48 V, transitioning to charging at 1.2 C up to 4.55 V, and then performing constant voltage charging at 4.55 V until a cut-off current is less than 0.32 C;

(2) 201-500 cls: charging at 4 C (16 A) up to 4.38 V, transitioning to charging at 3.2 C up to 4.43 V, transitioning to charging at 2.5 C up to 4.45 V, transitioning to charging at 2 C up to 4.48 V, transitioning to charging at 1.2 C up to 4.53 V, and then performing constant voltage charging at 4.53 V until a cut-off current is less than 0.32 C;

(3) 501-740 cls: (when the system at 35° C. circulates to 740 cls, the capacity retention rate reduces to 85%, the capacity is equal to 4000 mAh*85%, that is, 3400 mAh, and then the constant-current constant-voltage charging is transitioned to constant-capacity charging at 3400 mAh), charging at 4 C (16 A) up to 4.38 V, transitioning to charging at 3.2 C up to 4.43 V, transitioning to charging at 2.5 C up to 4.45 V, transitioning to charging at 2 C up to 4.48 V, transitioning to charging at 1.2 C up to 4.51 V, and then performing constant voltage charging at 4.51 V until a cut-off current is less than 0.32 C;

(4) 741 cls-1300 cls: charging at 4 C (16 A) up to 4.38 V, transitioning to charging at 3.2 C up to 4.43 V, transitioning to charging at 2.5 C up to 4.45 V, and transitioning to charging at 2 C until a charging total capacity reaches 3400 mAh, where in this process, the charging upper limit voltage is gradually increased;

(5) 1300-2000 cls: transitioning to constant-current constant-voltage charging again after constant-capacity charging is performed for a period of time, charging at 4 C (16 A) up to 4.38 V, transitioning to charging at 3.2 C up to 4.43 V, transitioning to charging at 2.5 C up to 4.45 V, transitioning to charging at 2 C up to 4.48 V, and then performing constant voltage charging at 4.48 V until a cut-off current is less than 0.32 C.

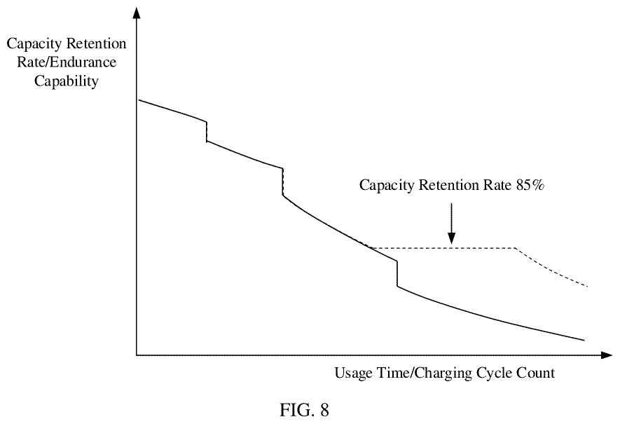

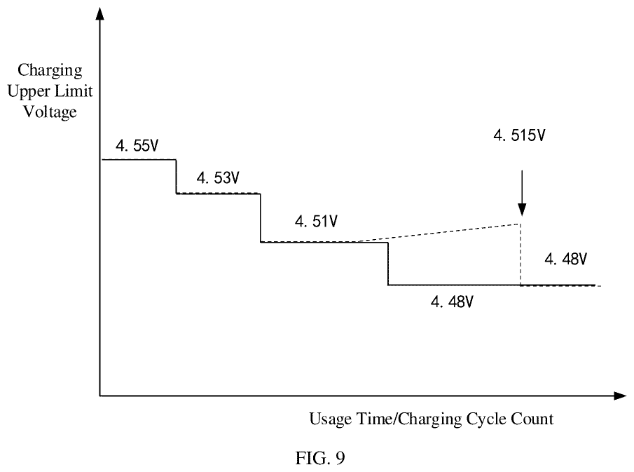

Based on the above, comparing the existing scheme with the capacity recovery scheme provided in the present disclosure, an effect comparison diagram (based on the capacity retention rate), shown in FIG. 8, of the conventional charging protocol and the capacity recovery scheme provided in the present proposal can be obtained, and another effect comparison diagram (based on the charging upper limit voltage), shown in FIG. 9, of the conventional charging protocol and the capacity recovery scheme provided in the present proposal can also be obtained. The solid line represents a conventional charging scheme, and the dashed line represents the capacity recovery scheme provided in the present proposal. It can be seen from FIG. 8 and FIG. 9 that the capacity recovery scheme provided in the present proposal is the same as the conventional charging scheme in a constant-current constant-voltage section, and the difference is that the active material waste and capacity loss caused by the buck operation is recovered through constant-capacity charging during the cycle process. After the capacity loss caused by the buck operation is recovered, the charging mode may be transitioned to the conventional charging again.

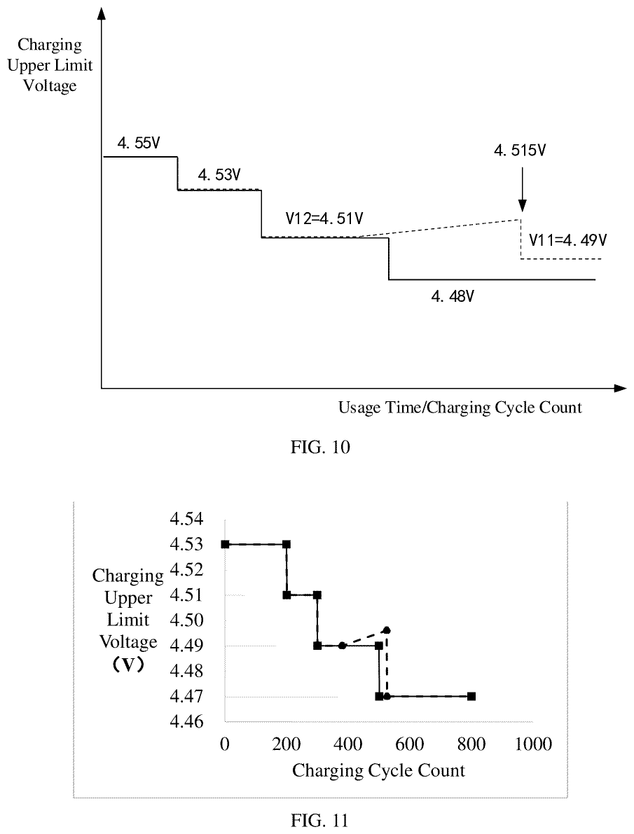

In another embodiment, in the 1300-2000 cls stage, a constant-capacity charging scheme provided in the present disclosure includes: transitioning to constant-current constant-voltage charging again after constant-capacity charging is performed for a period of time, charging at 4 C (16 A) up to 4.38 V, transitioning to charging at 3.2 C up to 4.43 V, transitioning to charging at 2.5 C up to 4.45 V, transitioning to charging at 2 C up to 4.48 V, transitioning to charging at 1.2 C up to 4.49 V, and then performing constant voltage charging at 4.49 V until a cut-off current is less than 0.32 C. Comparing this embodiment with the above embodiment, the difference between this embodiment and the above embodiment is that in a case that the charging mode based on the constant charging capacity is shut down, the real-time charging voltage of the lithium battery in some charging cycles is greater than the charging upper limit voltage corresponding to the constant charging capacity, as shown another effect comparison diagram of the conventional charging protocol and the capacity recovery scheme provided in the present proposal (based on the charging upper limit voltage) in FIG. 10. The scheme in this embodiment is also feasible, but the capacity recovery effect is not optimal due to the fact that the real-time charging voltage (such as V11) is greater than the charging upper limit voltage (such as V12) corresponding to the constant charging capacity.

In another specific embodiment, a fast charging system in which a voltage is 4.48 V, a capacity is 4740 mAh, a current is 3 C and FFC cycles are performed at 45° C. is taken as an example, and a conventional charging scheme in a full life cycle is shown in Table 1 below.

TABLE 1
Conventional Charging Scheme

| Cycles (cls) | Variation of Voltage and Current Values |
|---|---|
| 1-200 | 14.8 A-4.27 V-12 A-4.27 V-10 A-4.3 V-8 A-4.48 V-6.6 A-4.53 V-1.4 A |
| 201-300 | 14.8 A-4.27 V-12 A-4.27 V-10 A-4.3 V-8 A-4.48 V-6.6 A-4.51 V-1.4 A |
| 301-500 | 14.8 A-4.27 V-12 A-4.27 V-10 A-4.3 V-8 A-4.48 V-6.6 A-4.49 V-1.4 A |
| 501-800 | 14.8 A-4.27 V-12 A-4.27 V-10 A-4.3 V-8 A-4.47 V-6.6 A-4.47 V-1.4 A |

The constant capacity charging scheme provided by the present disclosure is shown in Table 2 below.

TABLE 2
Constant-Capacity Charging Scheme

| Cycles (cls) | Variation of Voltage and Current Values |
|---|---|
| 1-200 | 14.8 A-4.27 V-12 A-4.27 V-10 A-4.3 V-8 A-4.48 V-6.6 A-4.53 V-1.4 A |
| 201-300 | 14.8 A-4.27 V-12 A-4.27 V-10 A-4.3 V-8 A-4.48 V-6.6 A-4.51 V-1.4 A |
| 301-380 | 14.8 A-4.27 V-12 A-4.27 V-10 A-4.3 V-8 A-4.48 V-6.6 A-4.49 V-1.4 A |
| | (at this time, the capacity reduces to 85%, 4029 mAh) |
| 381-525 | 14.8 A-4.27 V-12 A-4.27 V-10 A-4.3 V-8 A-4.48 V-6.6 A-4029 mAh |
| | (the constant-capacity charging is performed in this stage |
| | with a constant capacity of 4029 mAh) |
| 526-800 | 14.8 A-4.27 V-12 A-4.27 V-10 A-4.3 V-8 A-4.47 V-6.6 A-4.47 V-1.4 A |

FIG. 11 is another effect comparison diagram (based on the charging upper limit voltage) of a conventional charging protocol and a capacity recovery scheme provided in the present proposal, as shown in FIG. 11, the solid line represents a conventional charging scheme, and the dashed line represents the capacity recovery scheme provided in the present proposal. The cycle count of this system is 380 cls when the cycling capacity of this system is reduced to 85% at 45° C. Therefore, before this cycle count of 380 cls, there is no difference between the constant-capacity charging scheme provided in the present disclosure and the conventional charging scheme, the voltage is reduced by 20 mV at 200 cls and 300 cls, respectively, and a cumulative buck loss is 4.500 (a sum of buck losses of two buck operations: 2.2%+2.3%). When the capacity is reduced to 85% (that is, the capacity is equal to 4029 mAh), the system of the present proposal is transitioned from the conventional constant-current constant-voltage charging to the constant-capacity charging, and the charging upper limit voltage is not limited in a subsequent period of time, so as to ensure that the capacity of each charging is 4029 mAh.

In this embodiment, with the implementation of the previous two buck operations, a capacity reduce rate becomes gentle. When the capacity is reduced to 85% (at 380 cls), a complete discharging curve obtained in the charging process is used to depict dQ/dV. According to dQ/dV, LAM and LLI are calculated, LAM is equal to 3.8%, and LLI is equal to 11.2% (a total capacity loss is 15%, since dQ/dV is drawn by using the discharging curve in the cycle process, the loss includes a part of power loss). At this time, after the charging cycle count of the constant-capacity charging transitioned from the constant-current constant-voltage charging reaches 144 cls, the LAM is increased by 4.5%, and the total LAM is equal to 3.8% plus 4.5%, which is 8.3%. The increased amount of LAM is equivalent to the buck loss, which fully recovers the loss caused by a material not being used due to the previous buck process, and then the charging mode is transitioned to the constant-current constant-voltage charging mode again, which is the same as the normal mode. By means of staged constant-capacity charging, the material loss caused by the current mainstream buck mode can be recovered, and the cycle life and the endurance time are improved.

In the embodiments of the present disclosure, in a process of charging a lithium battery according to a first charging mode, real-time service life information of the lithium battery is obtained, where the real-time service life information refers to information related to the service life of the lithium battery, and the first charging mode is a charging mode excepting a constant charging capacity charging mode (for example, the constant-capacity charging mode). When the real-time service life information meets a first preset condition, the lithium battery is charged according to the constant charging capacity charging mode, where the first preset condition is a first condition preset based on a full life cycle of the lithium battery. When the real-time service life information meets a second preset condition, the lithium battery is charged according to the first charging mode, where the second preset condition is a second condition preset based on the full life cycle of the lithium battery. When the lithium battery is used, in a process of charging the lithium battery according to the first charging mode, whether to start the constant charging capacity charging mode is determined according to the real-time service life information. Before the real-time service life information meets the second preset condition, the active material waste and a capacity loss caused by the capacity loss are recovered through the constant charging capacity charging mode. In this way, only the charging strategy of the lithium battery is changed, the lithium battery product itself is not changed, and the service life and the endurance capability of the lithium battery may be greatly improved.

Specifically, an existing charging protocol is constant-current constant-voltage charging, and once the buck operation is performed, a large amount of active material waste and capacity loss must be caused. After the charging cycle count reaches a certain extent, the constant-current constant-voltage charging is transitioned to the constant-capacity charging, the active material waste and the capacity loss caused by the buck operation may be recovered, and the cycle life and the endurance mileage are improved. Further, after the constant-current constant-voltage charging is performed to a certain extent (usually, the capacity retention rate is reduced to 80%-85%), the constant-current constant-voltage charging is transitioned to the constant-capacity charging, and after the constant-capacity charging is performed to a certain extent (after all the buck loss is completely recovered), the charging mode is transitioned to the constant-current constant-voltage charging again, so that the cycle life may be further prolonged.

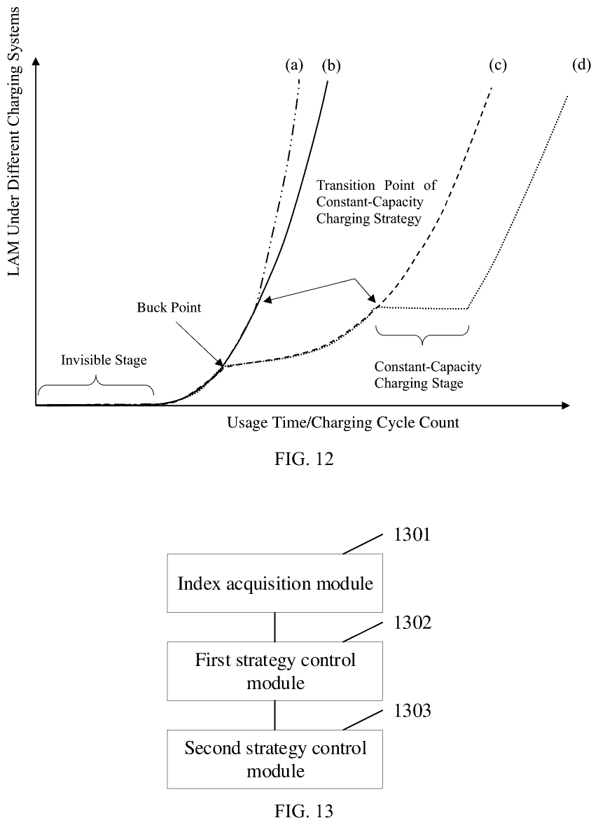

Further, as shown in FIG. 12, when the complete charging curve (or discharging curve) can be directly measured, the dV/dQ curve is drawn according to the small rate charging or discharging data (charging/discharging rate is less than or equal to 0.1 C) of the lithium battery, and an increasing trend of the LAM with the cycle count is decomposed from the dV/dQ curve. When a complete charging curve (or a discharging curve) cannot be obtained through measurement, a charging curve (or a discharging curve) is drawn according to an existing algorithm, and then the LAM is calculated.

The invisible stage in FIG. 12 refers to the LAM obtained by decomposition according to the charging curve (or discharging curve) of the lithium battery is equal to 0 (or very close to 0) during a certain period of time (such as, the previous 200 cls of the system in which the voltage is 4.5 V and the temperature is 45° C., or the previous 1000 cls of the system in which the voltage is 4.5 V and the temperature is 25° C., and the certain period of time is related to the system and the test temperature and the test mode) in the initial stage of the charging cycle, but the LAM obtained by a button cell test (coin cell test) is not zero. Because a result of the button cell test is a real material loss, while the LAM obtained by the charging or discharging curve is the LAM reflected in the full battery. During the initial stage of the charging cycle, LLI is much larger than LAM (LLI>>LAM), although there is a certain LAM, the LAM is not reflected in the charging curve (or discharging curve) of the lithium battery, that is, the influence of the LAM on the capacity retention rate is covered by the influence of the LLI on the capacity retention rate, so that the LAM decomposed from the charging or discharging curve of the lithium battery is displayed as zero. After the influence of the LAM on the capacity loss is greater than the influence of the LLI on the capacity loss, the LAM is greater than zero. Here, the button cell test refers to: an active material, conductive carbon black and a polymer were added into deionized water at a mass ratio of 80:10:10 and stirred into a slurry, and the slurry was made into a coating layer with a thickness of 100 um by using a scraper. After drying at 85° C. for 12 hours in a vacuum drying oven, the coating layer was cut into a circular sheet with a diameter of 1 cm as a working electrode by a punching machine in a dry environment. In a glove box, a metal lithium sheet was used as a counter electrode. The working electrode and the counter electrode were separated by a separator, an electrolyte was added, and a button cell is assembled. Charge and discharge capacities of the battery was tested by performing a charge and discharge test on the battery using a LAND series battery tester.

When the charging upper limit voltage of the lithium battery is not reduced and only the buck charging strategy is adopted, the change of the LAM loss over the charging cycle count (or the usage time) is shown as the curve (b) in FIG. 12, which increases exponentially.

A loss rate of the LAM is greatly reduced after one buck operation (in order to make the graph concise, one buck operation is taken as an example, and the effect of multiple buck operations is similar) is performed, as shown in the curve (c), which is an improvement brought by the conventional buck technology.

After the constant-capacity charging is started in the scheme of the present disclosure, the loss rate of the LAM is approximately as shown in the curve (d), the LAM reflected by the constant-capacity charging stage is basically unchanged, and the LAM rate after shutting down the constant-capacity charging strategy is approximately equal to the curve (c) (the curve (d) is parallel to the curve (c)). The mechanism is as follows: in a conventional buck system, the capacity loss ΔQ caused by the buck operation may be permanently lost because the active material corresponding to this part of capacity of the capacity loss is not utilized (but they also have electrochemical activity and can be utilized). After the charging mode is transitioned to the constant-capacity charging, the total charging capacity of the lithium battery is unchanged, the charging upper limit voltage of the lithium battery is slowly increased, and in this process, although the total charging capacity is unchanged, the lithium battery may also have a capacity loss. If there is no other compensation, with the increase of the charging upper limit voltage, the LAM of the lithium battery becomes faster and faster, resulting in accelerated reduction of the total capacity of the lithium battery, and the effect is as shown in the curve (a). In a case that the buck operation is not performed (the “other compensation” mentioned above), after the charging mode is transitioned to the constant-capacity charging mode at a specific point, compared with a conventional buck charging strategy (such as a curve (b)), the LAM rate is faster. However, the early buck operation results in a part of the active material not being utilized (that is, there is a buck loss ΔQ), in the process of adopting the constant-capacity charging strategy, LAM may be borne by the part of the active material, so that the active material not being utilized is transitioned from a state of “available but not utilized” to a state of “permanent LAM but not available”. In the two states, although the overall capacity losses are the same, the technical principles and technical effects are different. When the LAM in the constant-capacity charging stage is greater than or equal to the total capacity loss ΔQ caused by the buck operation, the active material not being utilized is completely transitioned to the LAM, and the material recovery is completed. At this time, if the constant-capacity charging is transitioned to the constant-voltage charging (the charging upper limit voltage no longer rises, and the total charging capacity of the lithium battery begins to decrease), the LAM rate of the system may not be accelerated as the effect of the curve (c). However, at this time, if the constant-capacity charging is maintained, the LAM of the system may accelerate, as shown in the curve (a), resulting in acceleration of the overall capacity loss.

Correspondingly, the embodiments of the present disclosure further provide a lithium battery, and the lithium battery is charged by using the charging method of the lithium battery provided by any one of the above embodiments.

Correspondingly, the embodiments of the present disclosure further provide a charging apparatus of a lithium battery, which is configured to charge a lithium battery.

As shown in FIG. 13, the charging apparatus of the lithium battery includes: an index acquisition module 1301 configured to: after reducing a charging upper limit voltage of the lithium battery according to a buck charging strategy, obtain first index information during a process that the lithium battery adopts the buck charging strategy; a first strategy control module 1302 configured to: when the first index information meets a first preset condition, shut down the buck charging strategy of the lithium battery and start a constant-capacity charging strategy of the lithium battery, where the constant-capacity charging strategy is a charging strategy based on a constant charging capacity, and the first preset condition is a first condition set based on a capacity loss caused by reducing the charging upper limit voltage of the lithium battery; and a second strategy control module 1303 configured to: after the lithium battery recovers at least part of the capacity loss through the constant-capacity charging strategy, shut down the constant-capacity charging strategy of the lithium battery.

In an embodiment, the second strategy control module 1303 is configured to: obtain second index information during a process that the lithium battery adopts the constant-capacity charging strategy; and when the second index information meets a second preset condition, shut down the constant-capacity charging strategy of the lithium battery and restart the buck charging strategy of the lithium battery, where the second preset condition is a second condition set based on the at least part of the capacity loss recovered through the constant-capacity charging strategy of the lithium battery.

In an embodiment, the index acquisition module 1301 is configured to: during the process that the lithium battery adopts the buck charging strategy, obtain a first real-time charging cycle count of the lithium battery. The first strategy control module 1302 is configured to: when the first real-time charging cycle count reaches a first preset cycle count, shut down the buck charging strategy of the lithium battery and start the constant-capacity charging strategy of the lithium battery, where the first preset cycle count is a charging cycle count set based on the capacity loss caused by reducing the charging upper limit voltage of the lithium battery.

In an embodiment, the second strategy control module 1303 is configured to: during the process that the lithium battery adopts the constant-capacity charging strategy, obtain a second real-time charging cycle count of the lithium battery; and when the second real-time charging cycle count reaches a second preset cycle count, shut down the constant-capacity charging strategy of the lithium battery and restart the buck charging strategy of the lithium battery, where the second preset cycle count is a charging cycle count set based on the at least part of the capacity loss recovered through the constant-capacity charging strategy of the lithium battery.

In an embodiment, the index acquisition module 1301 is configured to: during the process that the lithium battery adopts the buck charging strategy, obtain a corresponding relationship between a charging voltage and time or a discharging voltage and time of the lithium battery; based on the corresponding relationship between the charging voltage and time or the discharging voltage and time, obtain a corresponding relationship between a remaining power and an open circuit voltage of the lithium battery; and based on the corresponding relationship between the remaining power and the open circuit voltage, calculate a real-time capacity loss caused by reducing the charging upper limit voltage of the lithium battery. The first strategy control module 1302 is configured to: in a case that the real-time capacity loss reaches a preset loss threshold, shut down the buck charging strategy of the lithium battery and start the constant-capacity charging strategy of the lithium battery.

In an embodiment, the first strategy control module 1302 is configured to: in the case that the real-time capacity loss reaches the preset loss threshold, obtain a real-time capacity retention rate of the lithium battery; and when the real-time capacity retention rate is less than or equal to a preset retention rate threshold, shut down the buck charging strategy of the lithium battery and start the constant-capacity charging strategy of the lithium battery.

In an embodiment, the second strategy control module 1303 is configured to: during the process that the lithium battery adopts the constant-capacity charging strategy, obtain a corresponding relationship between a charging voltage and time or a discharging voltage and time of the lithium battery; based on the corresponding relationship between the charging voltage and time or the discharging voltage and time, obtain a corresponding relationship between a real-time capacity and a real-time voltage of the lithium battery; based on the corresponding relationship between the real-time capacity and the real-time voltage, calculate a loss of active material of the lithium battery; and when the loss of active material is greater than or equal to a total capacity loss caused by reducing the charging upper limit voltage of the lithium battery, shut down the constant-capacity charging strategy of the lithium battery and restart the buck charging strategy of the lithium battery.

In an embodiment, the first strategy control module 1302 is configured to: obtain a real-time charging current of the lithium battery and a real-time charging capacity of the lithium battery; and when the real-time charging current reaches a preset current threshold, maintain the real-time charging current unchanged, and continuously charge the lithium battery until the real-time charging capacity reaches the constant charging capacity.

In an embodiment, the charging apparatus of the lithium battery further includes a multi-start module, configured to: after restarting the buck charging strategy of the lithium battery, obtain third index information during a process that the lithium battery adopts the buck charging strategy; and when the third index information meets a third preset condition, shut down the buck charging strategy of the lithium battery again and restart the constant-capacity charging strategy of the lithium battery, where the third preset condition is a third condition set based on the capacity loss caused by reducing the charging upper limit voltage of the lithium battery.

In an embodiment, the preset current threshold is a current value corresponding to a charging upper limit voltage of the lithium battery under the constant charging capacity.

In an embodiment, the first strategy control module 1302 is configured to: obtain a real-time charging current of the lithium battery and a real-time charging capacity of the lithium battery; when the real-time charging current reaches a preset current threshold, maintain the real-time charging current unchanged, continuously charge the lithium battery, and obtain a real-time charging voltage of the lithium battery; and in a case that the real-time charging voltage reaches a system upper limit voltage, maintain the real-time charging voltage unchanged, and gradually reduce the real-time charging current until the real-time charging capacity reaches the constant charging capacity, where the system upper limit voltage is an upper limit voltage in a full life cycle of the lithium battery.

In an embodiment, the second strategy control module 1303 is configured to: when the second index information meets the second preset condition, charge the lithium battery according to a real-time charging voltage of the lithium battery being less than or equal to a charging upper limit voltage corresponding to the constant charging capacity.

In an embodiment, the constant charging capacity is preset based on a capacity retention rate of the lithium battery, and the capacity retention rate is greater than or equal to 80% and less than or equal to 85%.

The charging apparatus of the lithium battery provided in the present embodiments belongs to the same application concept as the charging method of the lithium battery provided in the foregoing embodiments of the present disclosure, can perform the charging method of the lithium battery provided in any of the foregoing embodiments of the present disclosure, and has corresponding functional modules and beneficial effects for executing the method. For technical details not described in detail in the present embodiments, reference may be made to specific processing contents of the charging method of the lithium battery provided in the foregoing embodiments of the present disclosure, and details are not described herein again.

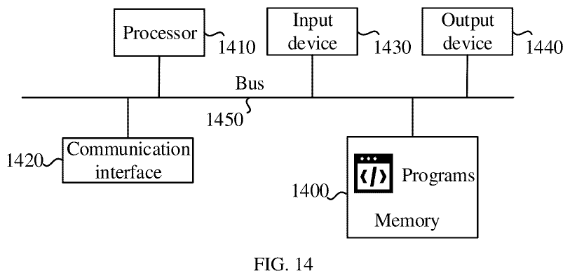

The embodiments of the present disclosure further provide an electronic device, and as shown in FIG. 14, the electronic device includes: a memory 1400 and a processor 1410.

The memory 1400 is connected to the processor 1410 and is configured to store programs.

The processor 1410 is configured to execute the programs stored in the memory 1400 to implement the charging method of the lithium battery according to the above embodiments.

Specifically, the electronic device may further include a communication interface 1420, an input device 1430, an output device 1440, and a bus 1450.

The processor 1410, the memory 1400, the communications interface 1420, the input device 1430, and the output device 1440 are connected to each other through the bus.

The bus 1450 may include a channel for transmitting information between various components of a computer system.

The processor 1410 may be a general-purpose processor, for example, a general-purpose Central Processing Unit (CPU), a microprocessor, or the like, or may be an Application-Specific Integrated Circuit (ASIC), or one or more integrated circuits configured to control program execution of the solutions of the present disclosure. It may also be a Digital Signal Processor (DSP), an Application-Specific Integrated Circuit (ASIC), a Field Programmable Gate Array (FPGA) or other programmable logic devices, a discrete gate or a transistor logic device, or a discrete hardware component.

The processor 1410 may include a main processor, and may further include a baseband chip, a modem, or the like.

The memory 1400 stores a program for executing the technical solutions of the present disclosure, and may further store an operating system and other key services. Specifically, the program may include program code, and the program code includes a computer operation instruction. More specifically, the memory 1400 may include a Read-Only Memory (ROM), other types of static storage devices that can store static information and instructions, a Random Access Memory (RAM), other types of dynamic storage devices that can store information and instructions, a magnetic disk memory, a flash, and the like.

The input device 1430 may include a device that receives data and information input by a user, such as a keyboard, a mouse, a camera, a scanner, a light pen, a voice input device, a touch screen, a pedometer, a gravity sensor, or the like.

The output device 1440 may include an apparatus that allows outputting information to a user, such as a display screen, a printer, a speaker, or the like.

The communication interface 1420 may include an apparatus using any device similar to a transceiver to communicate with other devices or communication networks, such as Ethernet, Radio Access Network (RAN), Wireless Local Area Network (WLAN), or the like.

The processor 1410 executes the program stored in the memory 1400, and invokes another device, to implement steps of the charging method of the lithium battery provided in the foregoing embodiments of the present disclosure.

In addition to the foregoing method and device, an embodiment of the present disclosure may further be a computer program product including computer program instructions. When the computer program instructions are executed by the processor, the processor implements steps of the charging method of the lithium battery provided in the embodiments of the present disclosure.

The computer program product may use any combination of one or more programming languages to write program codes for performing the operations of the embodiments of the present disclosure. The programming language includes an object-oriented programming language, such as Java, C++, or the like, and further includes a conventional procedural programming language, such as a “C” language or a similar programming language. The program codes may be executed entirely on a user computing device, partly on a user device, as a stand-alone software package, partly on the user computing device and partly on a remote computing device, or entirely on the remote computing device or server.

In addition, the embodiments of the present disclosure may also include a storage medium on which a computer program is stored, and the computer program is executed by the processor to perform the steps in the charging method of the lithium battery described in the embodiments of the present application.

For simplicity of description, the foregoing method embodiments are expressed as a series of action combinations, but a person skilled in the art should know that the present disclosure is not limited by the described action sequence, because some steps may be performed in other sequences or simultaneously according to the present disclosure. In addition, a person skilled in the art should also know that the embodiments described in this specification are preferred embodiments, and the involved actions and modules are not necessarily required in the present disclosure.

It should be noted that the embodiments in this specification are described in a progressive manner, each embodiment focuses on differences from other embodiments, and the same or similar parts among the embodiments may be referred by each other. As far as the apparatus embodiments are concerned, descriptions thereof are relatively simple since they are basically similar to the method embodiments, and for the relevant parts, reference may be made to the descriptions of the method embodiments.

The steps in the methods in the embodiments of the present disclosure may be adjusted in the sequence, combined, and deleted according to actual needs, and the technical features described in the embodiments may be replaced or combined.

Modules and sub-modules in each apparatus and each terminal in the embodiments of the present disclosure may be combined, divided, and deleted according to actual needs.

In the several embodiments provided in the present disclosure, it should be understood that the disclosed terminals, apparatuses, and methods may be implemented in other manners. For example, the terminal embodiments described above are merely illustrative, for example, division of modules or sub-modules is merely logical function division, and there may be other division manners in actual implementation. For example, a plurality of sub-modules or modules may be combined or may be integrated into another module, or some features may be ignored or not performed. In addition, the displayed or discussed mutual coupling or direct coupling or communication connection may be implemented through some interfaces. The indirect coupling or communication connection between the apparatuses or modules may be implemented in electrical form, mechanical form, or other forms.

The modules or sub-modules described as separate parts may or may not be physically separate, and parts serving as modules or sub-modules may or may not be physical modules or sub-modules, that is, may be located in one position, or may be distributed on a plurality of network modules or sub-modules. Some or all of the modules or sub-modules may be selected according to actual needs to achieve the objectives of the solutions of the embodiments in the present disclosure.

In addition, functional modules or sub-modules in the embodiments of the present disclosure may be integrated into one processing module, or each module or sub-module may exist alone physically, or two or more modules or sub-modules may be integrated into one module. The integrated module or sub-module may be implemented in a form of hardware, or may be implemented in a form of a software functional module or a sub-module.

Professionals may further realize that units and algorithm steps of each example described in combination with the embodiments disclosed in the disclosure may be implemented by electronic hardware, computer software, or a combination of the computer software and the electronic hardware. In order to clearly illustrate the interchangeability of hardware and software, the composition and steps of each example have been generally described in terms of functions in the foregoing description. Whether the functions are executed in a hardware or software manner depends on specific applications and design constraint conditions of the technical solutions. Professionals may use different methods to implement the described functions for each particular application, but it should not be considered that the implementation goes beyond the scope of the present disclosure. Professionals may realize the described functions for each specific application by using different methods, but such realization shall fall within the scope of the disclosure.

The steps of methods or algorithms described in combination with the embodiments disclosed in the disclosure may be implemented directly by a hardware, a software unit executed by a processor, or a combination of the two. The software unit may be placed in a Random Access Memory (RAM), a memory, a Read-Only Memory (ROM), an electrically programmable ROM, an electrically erasable programmable ROM, a register, a hard disk, a removable disk, a CD-ROM, or any other form of storage medium known in the art.

Finally, it should be further noted that, in this specification, relational terms such as first and second are only used to distinguish one entity or operation from another entity or operation, and do not necessarily require or imply that there is any such actual relationship or sequence between these entities or operations. Moreover, the terms “comprising”, “including” or any other variation thereof are intended to cover a non-exclusive inclusion, so that a process, method, article, or apparatus that includes a series of elements includes not only those elements, but also other elements that are not explicitly listed, or elements inherent to such a process, method, article, or apparatus. In a case without more restrictions, an element districted by the statement “includes a” does not exclude the existence of additional identical elements in the process, method, article, or apparatus including this element.

The above description of the disclosed embodiments enables a person skilled in the art to implement or use the present disclosure. Various modifications to these embodiments may be obvious to a person skilled in the art, and the general principles defined herein may be implemented in other embodiments without departing from the spirit or scope of the present disclosure. Therefore, the present disclosure is not be limited to the embodiments shown herein but is to be accorded the widest scope consistent with the principles and novel features disclosed herein.

What is claimed is:

1. A charging method of a lithium battery, comprising:
after reducing a charging upper limit voltage of the lithium battery according to a buck charging strategy, obtaining first index information during a process that the lithium battery adopts the buck charging strategy;
when the first index information meets a first preset condition, shutting down the buck charging strategy of the lithium battery and starting a constant-capacity charging strategy of the lithium battery, wherein the constant-capacity charging strategy is a charging strategy based on a constant charging capacity, and the first preset condition is a first condition set based on a capacity loss caused by reducing the charging upper limit voltage of the lithium battery; and
after the lithium battery recovers at least part of the capacity loss through the constant-capacity charging strategy, shutting down the constant-capacity charging strategy of the lithium battery.

2. The charging method of the lithium battery according to claim 1, wherein the after the lithium battery recovers at least part of the capacity loss through the constant-capacity charging strategy, shutting down the constant-capacity charging strategy of the lithium battery, comprises:
obtaining second index information during a process that the lithium battery adopts the constant-capacity charging strategy; and
when the second index information meets a second preset condition, shutting down the constant-capacity charging strategy of the lithium battery and restarting the buck charging strategy of the lithium battery, wherein the second preset condition is a second condition set based on the at least part of the capacity loss recovered through the constant-capacity charging strategy of the lithium battery.

3. The charging method of the lithium battery according to claim 1, wherein the obtaining first index information during a process that the lithium battery adopts the buck charging strategy, comprises:
during the process that the lithium battery adopts the buck charging strategy, obtaining a first real-time charging cycle count of the lithium battery,
wherein when the first index information meets the first preset condition, shutting down the buck charging strategy of the lithium battery and starting the constant-capacity charging strategy of the lithium battery, comprises:
when the first real-time charging cycle count reaches a first preset cycle count, shutting down the buck charging strategy of the lithium battery and starting the constant-capacity charging strategy of the lithium battery, wherein the first preset cycle count is a charging cycle count set based on the capacity loss caused by reducing the charging upper limit voltage of the lithium battery.

4. The charging method of the lithium battery according to claim 2, wherein the obtaining second index information during a process that the lithium battery adopts the constant-capacity charging strategy, comprises:
during the process that the lithium battery adopts the constant-capacity charging strategy, obtaining a second real-time charging cycle count of the lithium battery,
wherein when the second index information meets the second preset condition, shutting down the constant-capacity charging strategy of the lithium battery and restarting the buck charging strategy of the lithium battery, comprises:
when the second real-time charging cycle count reaches a second preset cycle count, shutting down the constant-capacity charging strategy of the lithium battery and restarting the buck charging strategy of the lithium battery, wherein the second preset cycle count is a charging cycle count set based on the at least part of the capacity loss recovered through the constant-capacity charging strategy of the lithium battery.

5. The charging method of the lithium battery according to claim 1, wherein the obtaining first index information during a process that the lithium battery adopts the buck charging strategy, comprises:
during the process that the lithium battery adopts the buck charging strategy, obtaining a corresponding relationship between a charging voltage and time or a discharging voltage and time of the lithium battery;
based on the corresponding relationship between the charging voltage and time or the discharging voltage and time, obtaining a corresponding relationship between a remaining power and an open circuit voltage of the lithium battery; and
based on the corresponding relationship between the remaining power and the open circuit voltage, calculating a real-time capacity loss caused by reducing the charging upper limit voltage of the lithium battery,
wherein when the first index information meets the first preset condition, shutting down the buck charging strategy of the lithium battery and starting the constant-capacity charging strategy of the lithium battery, comprises:
in a case that the real-time capacity loss reaches a preset loss threshold, shutting down the buck charging strategy of the lithium battery and starting the constant-capacity charging strategy of the lithium battery.

6. The charging method of the lithium battery according to claim 5, wherein in the case that the real-time capacity loss reaches the preset loss threshold, shutting down the buck charging strategy of the lithium battery and starting the constant-capacity charging strategy of the lithium battery, comprises:
in the case that the real-time capacity loss reaches the preset loss threshold, obtaining a real-time capacity retention rate of the lithium battery; and
when the real-time capacity retention rate is less than or equal to a preset retention rate threshold, shutting down the buck charging strategy of the lithium battery and starting the constant-capacity charging strategy of the lithium battery.

7. The charging method of the lithium battery according to claim 2, wherein the obtaining second index information during a process that the lithium battery adopts the constant-capacity charging strategy, comprises:
during the process that the lithium battery adopts the constant-capacity charging strategy, obtaining a corresponding relationship between a charging voltage and time or a discharging voltage and time of the lithium battery;
based on the corresponding relationship between the charging voltage and time or the discharging voltage and time, obtaining a corresponding relationship between a real-time capacity and a real-time voltage of the lithium battery; and
based on the corresponding relationship between the real-time capacity and the real-time voltage, calculating a loss of active material of the lithium battery,
wherein when the second index information meets the second preset condition, shutting down the constant-capacity charging strategy of the lithium battery and restarting the buck charging strategy of the lithium battery, comprises:
when the loss of active material is greater than or equal to a total capacity loss caused by reducing the charging upper limit voltage of the lithium battery, shutting down the constant-capacity charging strategy of the lithium battery and restarting the buck charging strategy of the lithium battery.

8. The charging method of the lithium battery according to claim 1, wherein a process that the lithium battery adopts the constant-capacity charging strategy, comprises:
obtaining a real-time charging current of the lithium battery and a real-time charging capacity of the lithium battery; and
when the real-time charging current reaches a preset current threshold, maintaining the real-time charging current unchanged, and continuously charging the lithium battery until the real-time charging capacity reaches the constant charging capacity.

9. The charging method of the lithium battery according to claim 8, wherein after restarting the buck charging strategy of the lithium battery, the charging method of the lithium battery further comprises:
obtaining third index information during a process that the lithium battery adopts the buck charging strategy; and
when the third index information meets a third preset condition, shutting down the buck charging strategy of the lithium battery again and restarting the constant-capacity charging strategy of the lithium battery, wherein the third preset condition is a third condition set based on the capacity loss caused by reducing the charging upper limit voltage of the lithium battery.

10. The charging method of the lithium battery according to claim 8, wherein the preset current threshold is a current value corresponding to a charging upper limit voltage of the lithium battery under the constant charging capacity.

11. The charging method of the lithium battery according to claim 1, wherein a process that the lithium battery adopts the constant-capacity charging strategy, comprises:
obtaining a real-time charging current of the lithium battery and a real-time charging capacity of the lithium battery;
when the real-time charging current reaches a preset current threshold, maintaining the real-time charging current unchanged, continuously charging the lithium battery, and obtaining a real-time charging voltage of the lithium battery; and
in a case that the real-time charging voltage reaches a system upper limit voltage, maintaining the real-time charging voltage unchanged, and gradually reducing the real-time charging current until the real-time charging capacity reaches the constant charging capacity, wherein the system upper limit voltage is an upper limit voltage in a full life cycle of the lithium battery.

12. The charging method of the lithium battery according to claim 2, wherein when the second index information meets the second preset condition, shutting down the constant-capacity charging strategy of the lithium battery and restarting the buck charging strategy of the lithium battery, comprises:
when the second index information meets the second preset condition, charging the lithium battery according to a real-time charging voltage of the lithium battery being less than or equal to a charging upper limit voltage corresponding to the constant charging capacity.

13. The charging method of the lithium battery according to claim 1, wherein the constant charging capacity is preset based on a capacity retention rate of the lithium battery, and the capacity retention rate is greater than or equal to 80% and less than or equal to 85%.

14. A lithium battery, comprising a controller, wherein the controller is configured to charge the lithium battery by using a charging method of the lithium battery, and the charging method of the lithium battery comprises:
after reducing a charging upper limit voltage of the lithium battery according to a buck charging strategy, obtaining first index information during a process that the lithium battery adopts the buck charging strategy;
when the first index information meets a first preset condition, shutting down the buck charging strategy of the lithium battery and starting a constant-capacity charging strategy of the lithium battery, wherein the constant-capacity charging strategy is a charging strategy based on a constant charging capacity, and the first preset condition is a first condition set based on a capacity loss caused by reducing the charging upper limit voltage of the lithium battery; and
after the lithium battery recovers at least part of the capacity loss through the constant-capacity charging strategy, shutting down the constant-capacity charging strategy of the lithium battery.

15. An electronic device, wherein the electronic device comprises a memory and a processor;
the memory is connected to the processor and is configured to store programs; and
the processor is configured to execute the programs stored in the memory to implement a charging method of a lithium battery, wherein the charging method of the lithium battery comprises:
after reducing a charging upper limit voltage of the lithium battery according to a buck charging strategy, obtaining first index information during a process that the lithium battery adopts the buck charging strategy;
when the first index information meets a first preset condition, shutting down the buck charging strategy of the lithium battery and starting a constant-capacity charging strategy of the lithium battery, wherein the constant-capacity charging strategy is a charging strategy based on a constant charging capacity, and the first preset condition is a first condition set based on a capacity loss caused by reducing the charging upper limit voltage of the lithium battery; and
after the lithium battery recovers at least part of the capacity loss through the constant-capacity charging strategy, shutting down the constant-capacity charging strategy of the lithium battery.

16. The electronic device according to claim 15, wherein the after the lithium battery recovers at least part of the capacity loss through the constant-capacity charging strategy, shutting down the constant-capacity charging strategy of the lithium battery, comprises:
obtaining second index information during a process that the lithium battery adopts the constant-capacity charging strategy; and
when the second index information meets a second preset condition, shutting down the constant-capacity charging strategy of the lithium battery and restarting the buck charging strategy of the lithium battery, wherein the second preset condition is a second condition set based on the at least part of the capacity loss recovered through the constant-capacity charging strategy of the lithium battery.

17. The electronic device according to claim 15, wherein the obtaining first index information during a process that the lithium battery adopts the buck charging strategy, comprises:
during the process that the lithium battery adopts the buck charging strategy, obtaining a first real-time charging cycle count of the lithium battery,
wherein when the first index information meets the first preset condition, shutting down the buck charging strategy of the lithium battery and starting the constant-capacity charging strategy of the lithium battery, comprises:
when the first real-time charging cycle count reaches a first preset cycle count, shutting down the buck charging strategy of the lithium battery and starting the constant-capacity charging strategy of the lithium battery, wherein the first preset cycle count is a charging cycle count set based on the capacity loss caused by reducing the charging upper limit voltage of the lithium battery.

18. The electronic device according to claim 16, wherein the obtaining the second index information during a process that the lithium battery adopts the constant-capacity charging strategy, comprises:
during the process that the lithium battery adopts the constant-capacity charging strategy, obtaining second real-time charging cycle count of the lithium battery,
wherein when the second index information meets the second preset condition, shutting down the constant-capacity charging strategy of the lithium battery and restarting the buck charging strategy of the lithium battery, comprises:
when the second real-time charging cycle count reaches a second preset cycle count, shutting down the constant-capacity charging strategy of the lithium battery and restarting the buck charging strategy of the lithium battery, wherein the second preset cycle count is a charging cycle count set based on the at least part of the capacity loss recovered through the constant-capacity charging strategy of the lithium battery.

19. The electronic device according to claim 15, wherein the obtaining first index information during a process that the lithium battery adopts the buck charging strategy, comprises:
during the process that the lithium battery adopts the buck charging strategy, obtaining a corresponding relationship between a charging voltage and time or a discharging voltage and time of the lithium battery;
based on the corresponding relationship between the charging voltage and time or the discharging voltage and time, obtaining a corresponding relationship between a remaining power and an open circuit voltage of the lithium battery; and
based on the corresponding relationship between the remaining power and the open circuit voltage, calculating a real-time capacity loss caused by reducing the charging upper limit voltage of the lithium battery,
wherein when the first index information meets the first preset condition, shutting down the buck charging strategy of the lithium battery and starting the constant-capacity charging strategy of the lithium battery, comprises:
when the real-time capacity loss reaches a preset loss threshold, shutting down the buck charging strategy of the lithium battery and starting the constant-capacity charging strategy of the lithium battery.

20. The electronic device according to claim 19, wherein when the real-time capacity loss reaches the preset loss threshold, shutting down the buck charging strategy of the lithium battery and starting the constant-capacity charging strategy of the lithium battery, comprises:
in a case that the real-time capacity loss reaches the preset loss threshold, obtaining a real-time capacity retention rate of the lithium battery; and
when the real-time capacity retention rate is less than or equal to a preset retention rate threshold, shutting down the buck charging strategy of the lithium battery and starting the constant-capacity charging strategy of the lithium battery.
